(19) United States
(12) Patent Application Publication
(10) Pub. No.: US 2001/0022783 A1
(43) Pub. Date: Sep. 20, 2001

(54) Wireless internet access system

(76) Inventor: Masahiro Ohki, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/801,659

(22) Filed: Mar. 9, 2001

(30) Foreign Application Priority Data
Mar. 14, 2000 (JP) 2000-070549

(51) Int. Cl. H04Q 7/24; H04L 12/28; H04L 12/56

(52) U.S. Cl. 370/338; 370/401

(57) ABSTRACT

An object of the present invention is to provide a system that avoids degradation of the reception quality, when the timing of antenna control overlaps with the timing of user data reception. When the timing of an antenna beacon signal reception has fallen upon the reception of user data, an antenna control disable signal is generated according to the detection of a start delimiter. The control of the antenna is thereby prohibited. The occurrence of errors in the reception data is thereby avoided. The antenna beacon reception signal is held in accumulation means. At the time of the end of the reception data, the control of the antenna is started. Thereby, the degradation in the quality of the transmission data is avoided as the entire system even without adversely affecting the control of the antenna.

### BACKGROUND OF THE INVENTION

1. Technical Field of the Invention

The present invention relates to a wireless internet access system, particularly to a high-speed wireless internet access system wherein terminals connected with a flying LAN in an airplane are connected to an internet on the ground.

2. Description of the Prior Art

In a next-generation mobile communication such as IMT2000 (international mobile telecommunications 2000), in a state where the movement of a mobile object is to an extent of a walking, a bearer service of 384 kbps (kilo-bit/sec) is supported while in a state where it is fixed the one of 2 Mbps (mega-bit/sec) is supported.

Also, in a high-speed wireless access using a frequency band of 5 GHz, a wireless LAN (local area network) and an outdoor high-speed wireless access service are being studied.

On the other hand, in a fixed network, due to very rapid development and progress of the internet, the actual circumstance is such that the amount of data traffic has already exceeded the amount of speech traffic. And, some of service carriers has begun to support telephone services by using IP (internet protocol) network, in place of the conventional public telephone network.

In view of the above-described existing circumstances, from now onward, it is anticipated that demands for accessing to high speed internet services increase. This indicates that both the fixed network and the mobile network will evolve into a network wherein IP traffic is easy to handle. In the future, it is anticipated that the fixed networks and the mobile networks including high-speed wireless accesses will be integrated.

As an integrated network of the fixed network and the mobile network, for example, a flying LAN such as shown in FIG. 1 is being studied. Referring to FIG. 1, within an airplane 10, an Ethernet 20 is provided as a LAN. Passengers on board can access to an internet 60 by using a terminal 40 from their seats. In this Ethernet 20, there is used a flying router 30, by means of which the passenger can access to the internet 60 via a wireless earth station 50.

In the above-described network, the following two requirements should be taken into consideration.

(1) The wireless distance between the mobile object (airplane) 10 and the wireless earth station 50 should support a transmission rate with compatibility of Ethernet, higher than about 20 Mbps, because overheads are required between the wireless section.

(2) From the viewpoint of the frequency resources and wide-band communication, a microwave frequency band of higher than 5 GHz may possibly be used.

When the transmission rate becomes high and the frequency band for use becomes high under the assumption that the transmission power be fixed, the transmission distance becomes short in inverse proportion to the transmission rate and in inverse proportion to the square of the frequency. As a result, the service area becomes narrow.

Therefore, in addition to the above-mentioned conditions (1) and (2), other conditions should be fulfilled in order to cover sufficiently a necessary service area (the distance between the mobile object 10 and the wireless earth station 50).

(3) The wireless earth station 50 must use high directionality antenna or high gain antenna in order to cover the above-described necessary service area.

Here, although it is desirable that also the antenna of the mobile object (airplane) 10 is of high directivity, direction controls of the antennas of the mobile object 10 and the earth station 50 becomes extremely difficult. Therefore, that is not advisable. Accordingly, the antenna of the mobile object 10 unavoidably becomes simple one which can be merely tilted.

(4) The antenna of the wireless earth station 50 should be provided with the automatic tracking function for the mobile object 10. If the earth antenna can not track the mobile object 10 automatically, it is impossible to obtain a prescribed value of antenna gain, so that the transmission quality becomes extremely deteriorated.

Because the antenna of the mobile object 10 is of low directivity, delay waves may possibly be generated by geographical conditions.

(5) The wireless earth station 50 side should provide for means for decreasing the code-to-code interference due to the delay waves.

FIG. 7 is a block diagram of exemplary wireless earth station 50 that satisfies the above-mentioned conditions (3) to (5).

Referring to FIG. 7, this wireless earth station 50 is equipped with an antenna 100, an antenna control unit 250, an antenna beacon signal receiver 300, a wireless modem 460, and a router 800. The antenna beacon signal receiver 300 outputs an antenna control signal 301 to an antenna control unit 250. The antenna control unit 250 receives the antenna control signal 301 and outputs a signal 201 for performing directional control of the antenna 100.

FIG. 8 is a block diagram of a wireless router 300 of the mobile object 10. Referring to FIG. 8, the wireless router 30 is equipped with an antenna 500, a wireless modem 600, an antenna beacon signal generator 700, and a router 850 connected to the Ethernet within the mobile object 10. An antenna beacon signal outputted from the antenna beacon signal generator 700 is transmitted from the antenna 500.

FIG. 9 is a block diagram of the wireless modem 460 of the wireless earth station 50. Referring to FIG. 9, the wireless modem 460 is equipped with a frequency down converter 401, a frequency up-converter 402, a quadrature demodulator 403, a quadrature modulator 404, an A/D converter 405, a D/A converter 406, an equalizer 407, a transmission encoder 408, a start delimiter detection unit 409, and a wireless frame composing and decomposing unit 410.

FIG. 6 shows an example of a frame format of the wireless modem 460. As shown in FIG. 6, the frame comprises a preamble signal 421 and a payload 422. The preamble signal 421 includes a signal 423 (referred to as “a wireless-portion establishing signal” as well) for carrier detection or AGC (automatic gain control), an equalizer training signal 424, and a start delimiter 425 for discriminating a starting point of the payload portion in the frame.

FIG. 11 is a timing chart of the signal flow (operation timing) of the wireless earth station 50. In FIG. 11, a reference numeral 11 denotes an antenna beacon signal transmitted from the mobile object 10, a reference numeral 12 denotes an antenna control enable signal indicating a time period for receiving the antenna beacon signal and for determining the optimum antenna direction, and a reference numeral 13 denotes a burst signal transmitted from the mobile object 10.

In this conventional system, the antenna direction is controlled in such a manner that the antenna 100 on the wireless earth station (base station) 50 side may be always directed toward the mobile object existing within the station itself (the station's own area). This directional control is performed, for example, as follows.

As shown in FIG. 11, the wireless router 30 of the mobile object 10 transmits the antenna beacon signal 11 that is periodically outputted from the antenna beacon signal generator 700 (the period T1).

In the wireless earth station 50, the antenna beacon signal from the mobile object 10 is received by antenna signal receiver 300.

The antenna control unit 250 controls the direction of the antenna so that the received level of the antenna beacon signal may become maximum.

The time period for antenna control is T2 shown by the numeral 12 as shown in FIG. 11.

It is assumed that in this system the antenna beacon control signal (11 as shown in FIG. 11) and the user data signal (the frame format as shown in FIG. 6) are transmitted by using their own separate frequencies, respectively. It is also assumed that the FDD (Frequency Division Duplex) is adopted for the transmission and reception of user data between the mobile object 10 and the wireless earth station 50.

Basically in such a system, the user data can be received, at the same time when the direction of the antenna on the side of the wireless earth station 50 is being controlled.

On the wireless earth station 50 side, burst signal 13 in the frame format as shown in FIG. 6 is received as shown in FIG. 11.

The outline of the reception operation of the wireless modem 400 in the wireless earth station 50 is explained with reference to FIG. 9. The frequency of the signal from the antenna 100 as shown in FIG. 7 is converted to a prescribed intermediate frequency (IF) by means of the frequency down-converter 401. Then, the output from the down converter is converted to a baseband signal by the quadrature demodulator 403.

Then, the baseband signal is converted into a digital baseband signal by the A/D converter 405. Here, when AGC control is completed by the establishment signal 423 in the preamble signal 421 as shown in FIG. 6, a training in the equalizer 407 is started.

The equalizer 407 may be a Viterbi equalizer.

Generally, under the so-called “time-invariant” environment of transmission channel wherein the length of the burst is relatively short and the impulse response of the transmission channel does not change in the burst, the tap coefficient of the Viterbi equalizer is fixed or frozen, if within the frame period, to a coefficient that has been determined during the training period of time. Hereinafter, the description will be made under the assumption that the environment of transmission channel is time-invariant.

First, the impulse response of the transmission channel is estimated, by using a known training signal.

Next, the tap coefficient of the Viterbi equalizer 407 that has been determined through the estimation of the transmission channel is made fixed (frozen). Thereafter, the start delimiter detection unit 409 starts detecting the start delimiter 425 embedded at the end of the preamble signal 421.

When the start delimiter 425 is detected, the signal bits from the next bit are deemed to be effective data, thereby receiving the user data.

In this way, the user data received by the wireless earth station 50 are transmitted from the modem 460 to the router 800 and are then packeted into an IP packet which is transmitted out into the internet 60.

In the above-described conventional technique, because the antenna and the wireless modem are controlled independently, the construction and control of the earth station become simplified. However, the above-described conventional technique has the following disadvantages.

Concretely, the above-described conventional technique as shown in FIG. 11 works well, when the time period for the antenna control does not overlap with the time period for the user data reception. However, a problem arises, when there is a timing at which the time period for antenna control overlaps with the time period for user data reception, as shown in FIG. 10.

In FIG. 10, a reference numeral 11 denotes an antenna beacon signal, a reference numeral 12 denotes an antenna control enable signal, a reference numeral 13 denotes a burst signal transmitted from the mobile object, and a reference numeral 14 denotes a fluctuation in phase of the transmission channel which occurs when the timing of receiving the user data has fallen upon the time period of antenna control.

The transmission channel is regarded as being time-invariant within a frame. Therefore, the tap coefficient of the Viterbi equalizer is made fixed (frozen) within the frame.

Therefore, at a point t1 in time of FIG. 10, when the antenna direction is determined and the direction of the antenna is changed, the impulse response of the transmission channel changes.

And, when the phase component of the impulse response 14 of the transmission channel fluctuates during receiving the user data, as shown in FIG. 10, errors in estimating the received data modulated by phase modulation may occur, because the tap coefficient of the Viterbi equalizer is frozen.

Therefore, the equalizer is made adaptive in order to change gradually the tap coefficient in accordance with a change in the impulse response of the transmission channel. However, when the impulse response changes sharply, a high-speed convergent algorithm such as an RLS (Recursive Least Square) is required. In this case, the RLS or the like makes the equalizer complicated in a high-speed modem wherein the equalizer is a hardware circuit.

In this way, the conventional technique has a disadvantage that the ability of the Viterbi equalizer to estimate the reception data becomes deteriorated and the receiving quality is degraded, when the timing of the antenna control overlaps with the timing of the data reception.

To avoid the occurrence of the above-described problem, it may be thought that it is sufficient to make the antenna beacon signal not overlap with the transmission timing of the user data on the side of the mobile object. However, when the antenna gain is low, it is necessary to employ a high directionality antenna and to perform directional control thereof in the same manner as on the earth station, on the side of the mobile object as well.

In the FDD, the up link is not synchronized with the down link. Therefore, the above-described problem is not solved merely by controlling the antenna and the equalizer only on the transmission side.

Accordingly, the present invention has been made in view of the above-described points of problem and has an object to provide a system which reduces the degradation of the reception quality, when the antenna control timing overlaps with the timing for the user data reception.

The present invention that achieves the above object is equipped with means which processes the timings of antenna control and equalizer control in an exclusive manner, when they overlap with each other.

The high sped wireless internet access system of the present invention is a mobile network/fixed network integrated system. The mobile object is provided with a LAN connected with a router and a plurality of user terminals. The router is equipped with means for performing bi-directional wireless communication with an earth station. The earth station comprises antenna control means for controlling the antenna direction while the antenna traces the mobile object, a wireless modem and a router for accessing to the internet, and timing delay means for delaying the timing of antenna control, when the antenna control timing overlaps with the data reception timing on the earth station.

According to the present invention, the reception of the user data and the control of the antenna direction are differentiated from each other in terms of the timing. This provides the effect of enabling high-speed wireless internet access of a high quality of transmission data.

### BRIEF EXPLANATION OF THE DRAWINGS

FIG. 1 is a diagram showing an example of the construction of a high-speed wireless internet access system having applied thereto the present invention.

FIG. 2 is a diagram showing the construction of a earth station according to an embodiment of the present invention.

FIG. 3 is a diagram showing the construction of an antenna control unit according to the embodiment of the present invention.

FIG. 4 is a diagram showing an example of the construction of a wireless modem according to the embodiment of the present invention.

FIG. 5 is a diagram showing the operation timing in the embodiment of the present invention.

FIG. 6 is a diagram showing the format of a wireless signal frame according to the present invention and a conventional technique.

FIG. 7 is a diagram showing the construction of a earth station according to the conventional technique.

FIG. 8 is a diagram showing the construction of a wireless router in a mobile object according to the conventional technique.

FIG. 9 is a diagram showing the construction of a wireless modem in the mobile object according to the conventional technique.

FIG. 10 is a diagram showing the operation of the conventional technique.

FIG. 11 is a diagram showing the operation of the conventional technique.

### PREFERRED EMBODIMENT OF THE INVENTION

An embodiment of the present invention will hereafter be explained. The present invention is directed to an exclusive processing of the timings of antenna control and equalizer control, when they overlap with each other. The “exclusive processing” is to cause preference to be taken of the equalizer control over the antenna control, i.e. performing a control of postponing the antenna control during the reception of the user data. More specifically, in a preferred embodiment thereof, the system of the present invention is equipped on the wireless modem side of the earth station side the following means. That is, the system of the present invention includes: disable signal generating means for generating a disable signal for antenna control at the start delimiter on the earth station side; and antenna control start means for starting the antenna control on the basis of the antenna control disable signal and antenna control enable signal. Concretely, when the antenna control disable signal is active, the antenna control start means starts stores the antenna beacon signal, when the antenna control enable signal becomes active (on), and it stops the antenna control. Further, it starts the antenna control, when the antenna control disable signal becomes inactive (off).

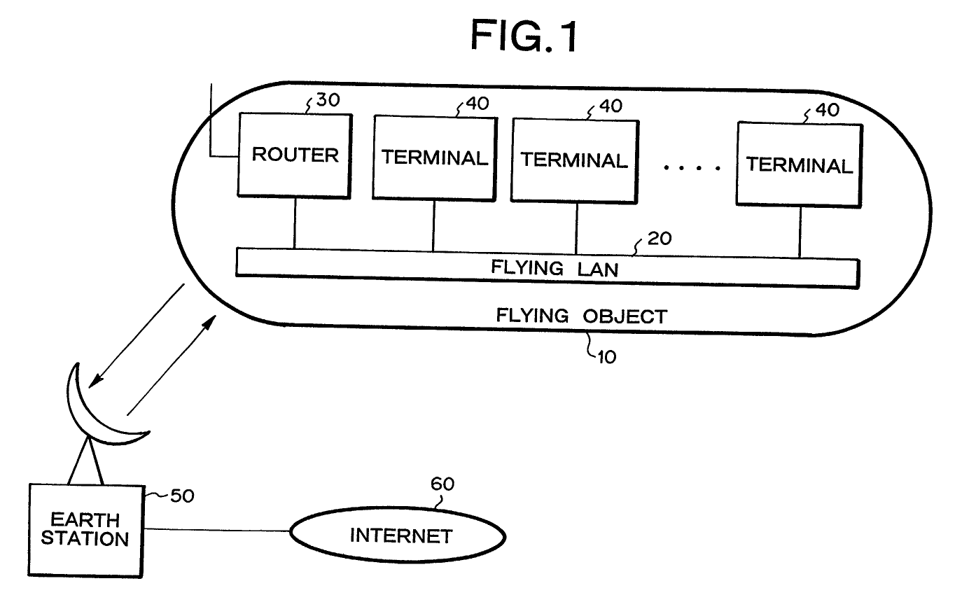

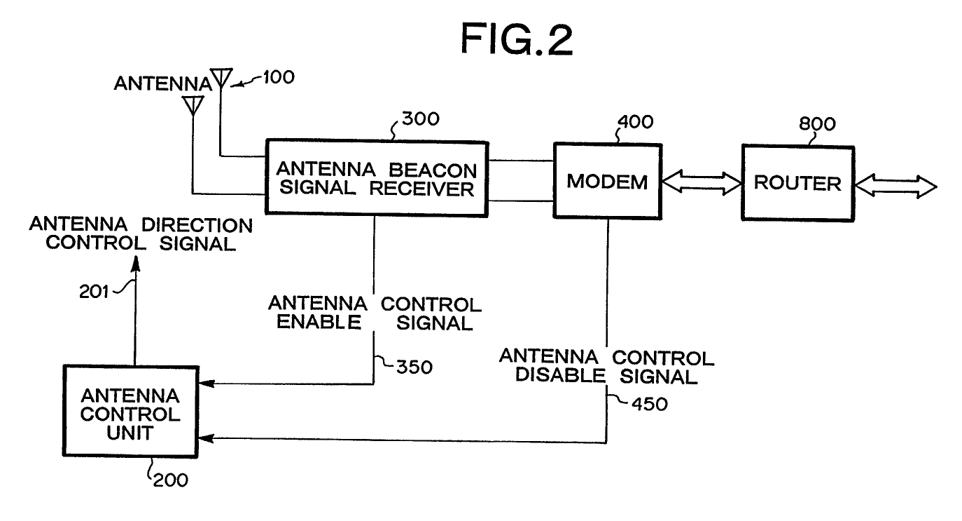

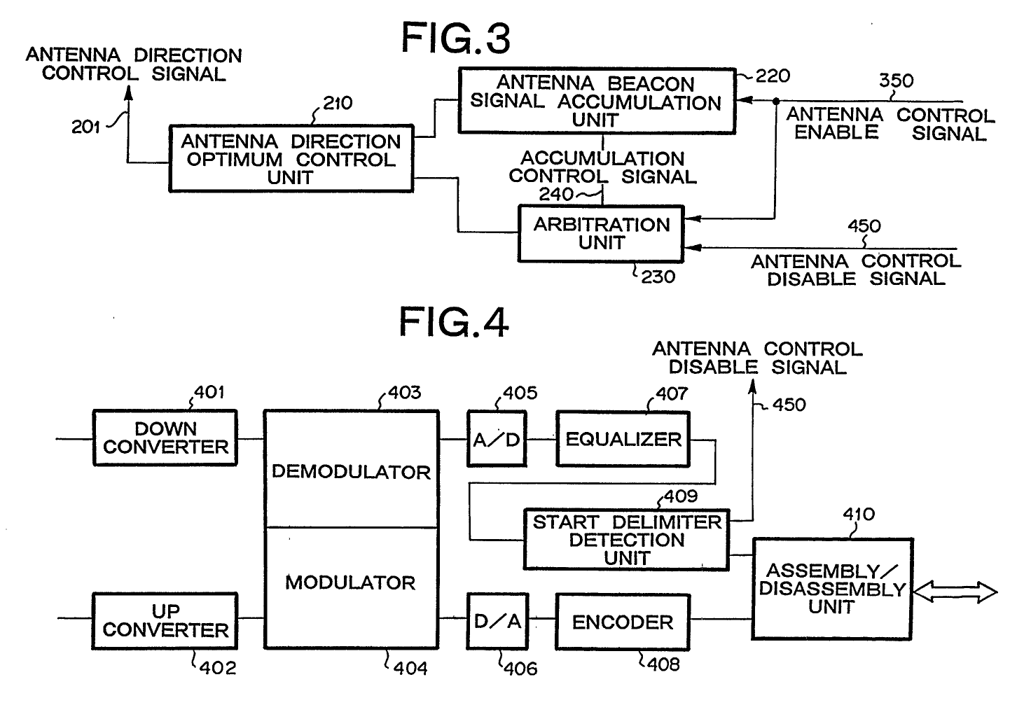

In the embodiment of the present invention, referring to FIGS. 1 and 2, there is provided a wireless earth station (50) for performing wireless communication with a router (30) on a mobile object (10) and thereby performing connection with an internet (60). The wireless earth station (50) is equipped with an antenna (100) for performing wireless communication with the mobile object (10), an antenna control unit (200) for performing automatic tracking of the antenna (100), an antenna beacon signal receiver (300), a wireless modem (400), and a router (800). The wireless modem (400) is equipped with means for generating an antenna control disable signal (450), when it detects a start delimiter for discriminating a starting point of the payload in the frame. The antenna control unit (200) accepts an antenna control enable signal (350) outputted from the antenna beacon signal receiver (300) and an antenna control disable signal (450) outputted from the wireless modem (400). During the period when the antenna control disable signal (450) is active (on), the antenna control unit (200) stores the antenna beacon signal in the accumulation unit (220) as shown in FIG. 3, when the antenna control enable signal (350) from the antenna beacon signal receiver (300) becomes active (on), and it stops temporarily the antenna control. Further, it starts the antenna control, when the antenna control disable signal (450) becomes inactive (off).

In the embodiment of the present invention, referring to FIG. 3, the antenna control unit (200) is equipped with an antenna direction optimum control unit (210) that performs optimum control of the direction of the antenna (100), an antenna beacon signal accumulation unit (220), and an arbitration unit that inputs the antenna control enable signal and the antenna control disable signal and that outputs to an antenna beacon signal accumulation unit (220) a signal that controls write and read of the antenna beacon signal.

In the embodiment of the present invention, the wireless modem is equipped with a frequency down-converter (401), an quadrature demodulator (403) that inputs an output of the frequency down-converter (401), an A/D converter (405) that converts an quadrature demodulation output to a digital signal and outputs this digital signal, an equalizer (407), a start delimiter detection unit (409), a wireless frame assembly/disassembly unit (410), a transmission encoder (408), a D/A converter (406) that converts an output of the transmission encoder to an analog signal and outputs this analog signal, an quadrature modulator (404) that performs quadrature modulation of an output of the D/A converter, and a frequency up-converter (402) that inputs an output of the quadrature modulator (404). When the start delimiter detection unit (409) detects a start delimiter of the preamble portion of the frame, it outputs the antenna control disable signal (450) to the antenna control unit (200).

According to the embodiment of the present invention, when the receiving timing of the antenna beacon signal has fallen upon the receiving timing of the user data, the control of the antenna is prohibited by the antenna control disable signal generating due to the detection of the start delimiter.

Therefore, it is possible to avoid the disadvantage that in the conventional technique errors are made in the reception of the data due to the performance of the directional control of the antenna during the reception of the data as stated previously.

Also, in the embodiment of the present invention, the antenna beacon signal is stored in the accumulation means, and is read out by antenna control start means, when the reception of data is ended. Therefore, it is possible to avoid the degradation of the quality of the transmission data.

In order to explain the above-described embodiment of the present invention more concretely in more detail, an example of the embodiment thereof will hereafter be explained with reference to the drawings. The system to which the present invention is applied is the same construction as shown in FIG. 1. The Ethernet 20 is laid within the airplane 10. The terminal 40 has access to the internet 60 via the router 30 of the Ethernet 20 and via the wireless earth station 50.

FIG. 2 is a diagram showing an example of the construction of the wireless earth station 50 according to the embodiment of the present invention. Referring to FIG. 2, the wireless earth station 50 is equipped with the antenna 100, the antenna control unit 200, the antenna beacon signal receiver 300, the wireless modem 400, and the router 800.

The antenna beacon signal receiver 300 outputs the antenna control enable signal 350 to the antenna control unit 200. The wireless modem 400 outputs the antenna control disable signal 450 to the antenna control unit 200.

FIG. 3 is a diagram showing an example of the construction of the antenna control unit 200 according to the embodiment of the present invention. Referring to FIG. 3, the antenna control unit 200 is equipped with the antenna direction optimum control unit 210, antenna beacon signal accumulation unit 220, and the arbitration unit 230 of the antenna control enable signal and the antenna control disable signal.

The arbitration unit 230 inputs the antenna control enable signal 301 and the antenna control disable signal 450 and thereby outputs to the antenna beacon signal accumulation unit 220 a signal 240 that controls write and read of the antenna beacon signal.

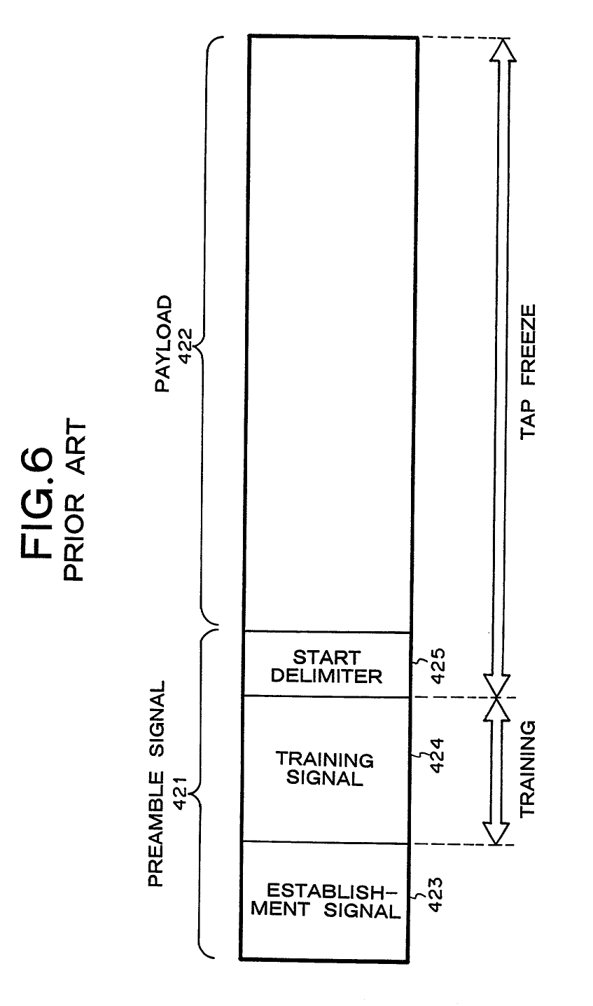

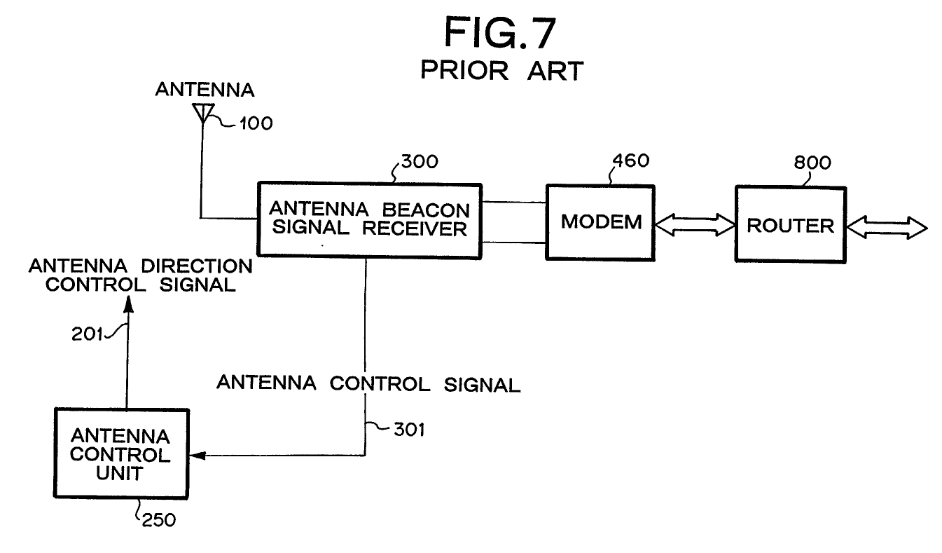

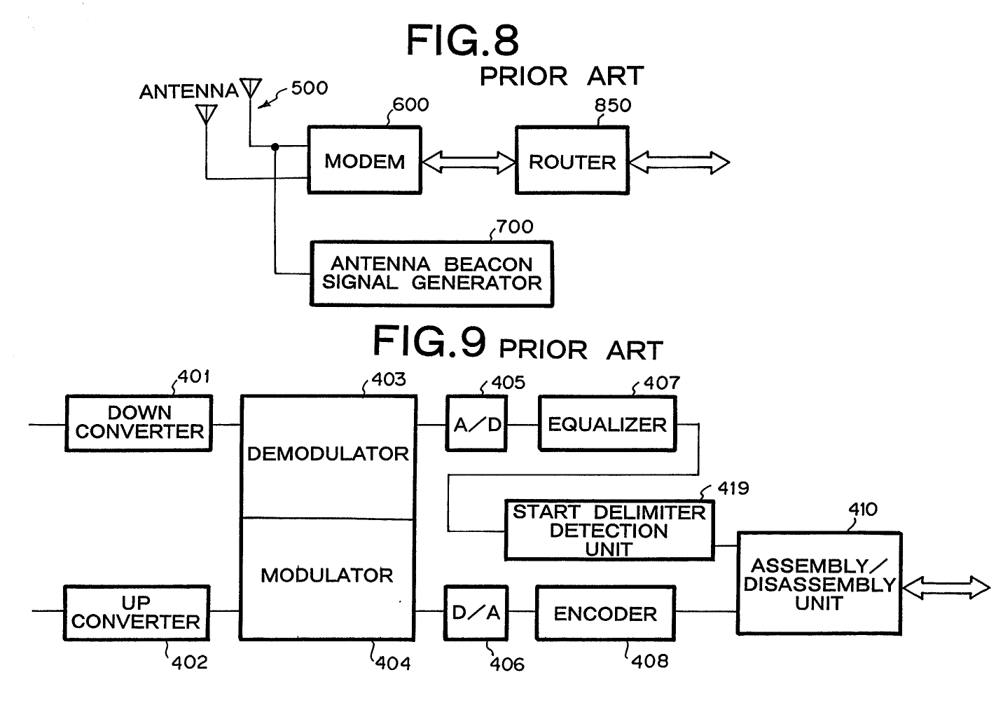

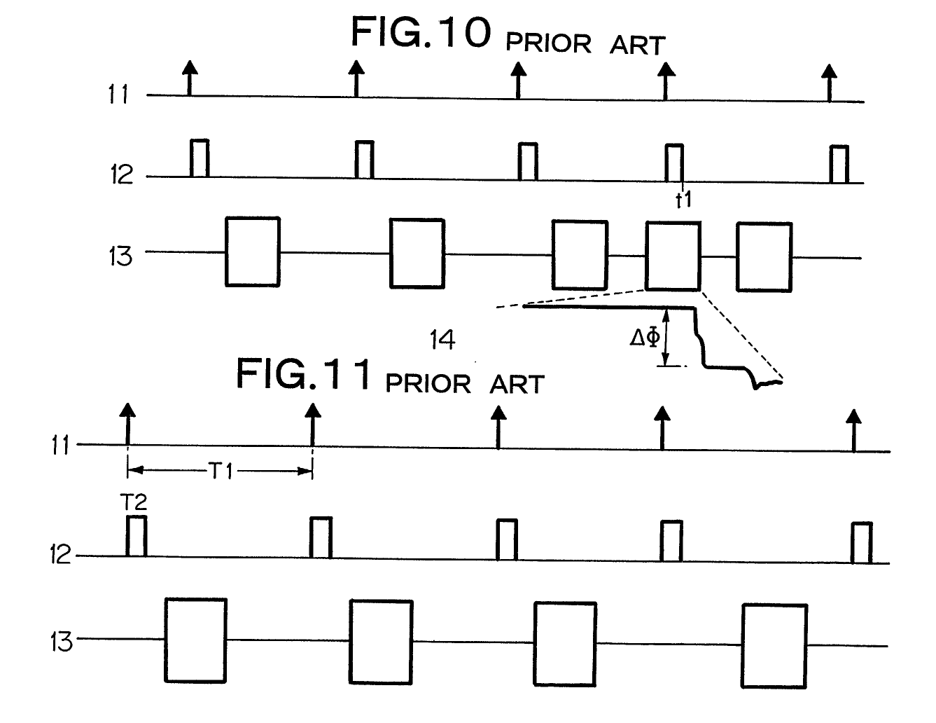

FIG. 4 is a diagram showing an example of the construction of the wireless modem 400 according to the embodiment of the present invention. Referring to FIG. 4, the wireless modem 400 is equipped with a frequency down-converter 401, an quadrature demodulator 403 that inputs an output (intermediate frequency signal) of the frequency down-converter 401, an A/D converter 405 that converts an quadrature demodulation output to a digital signal and outputs this digital signal, an equalizer 407 that inputs an output of the A/D converter 405, a start delimiter detection unit 409 that inputs an output of the equalizer 407 and detects a start delimiter, a wireless frame assembly/disassembly unit 410, a transmission encoder 408, a D/A converter 406 that converts an output of the transmission encoder 408 to an analog signal and outputs this analog signal, an quadrature modulator 404 that performs quadrature modulation of an output of the D/A converter 406, and a frequency up-converter 402 that inputs an output of the quadrature modulator 404. The format of the wireless frame is made the same as the one shown in FIG. 6.

The start delimiter detection unit 409 outputs the antenna control disable signal 450 to the antenna control unit 200.

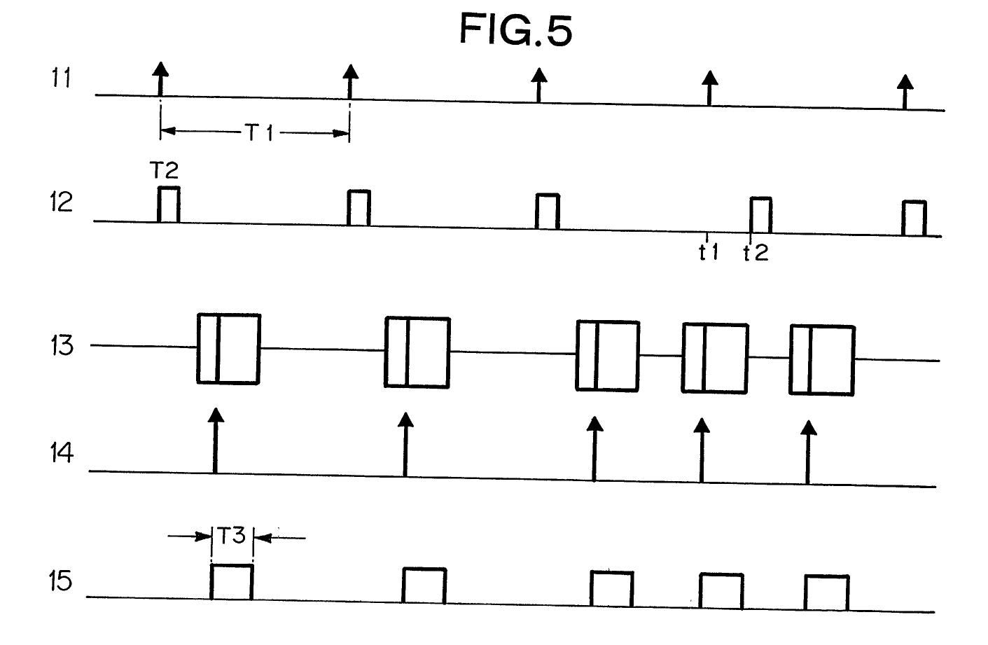

FIG. 5 is a diagram showing an example of the timing operation in the embodiment of the present invention. In FIG. 5, a reference numeral 11 denotes the antenna beacon signal from the mobile object, a reference numeral 12 denotes the antenna control enable signal that receives the antenna beacon signal to thereby indicate a time period during which to determine an optimum direction of the antenna, a reference numeral 13 denotes the burst signal from the mobile object 10, a reference numeral 14 denotes the start delimiter detection timing, and a reference numeral 15 denotes the antenna control disable signal, respectively.

The operation of an example of the embodiment of the present invention will now be explained. In FIG. 2, in the earth station 50, the antenna beacon signal (11 of FIG. 5) from the flying router 30 (see FIG. 1) of the mobile object 10 is received by the antenna beacon signal receiver 300. As a consequence, the antenna control enable signal 350 becomes active (ON) (the time period T2 of the reference numeral 12 of FIG. 5).

At this time, in case the antenna control disable signal 450 from the wireless modem 400 is OFF, the antenna control enable signal 350 is inputted to the antenna control unit 200. Thereby, during the time period T2, the antenna control unit 200 performs directional control of the antenna so that the reception level of the antenna beacon signal may become maximal.

Here, the antenna direction optimum control unit (210) of FIG. 3) in an example of the embodiment of the present invention is equipped with known means that mechanically or electronically can perform its necessary operation. The mechanical means may be known automatic tracking means that is used for tracking satellites, while the electronic means may include known means such as a digital beam forming that uses an array antenna.

With reference to FIG. 4, the operation of the wireless modem 400 will be explained. The signal received by the antenna 100 (see FIG. 2) is converted to a prescribed intermediate frequency (IF signal) by the frequency down-converter 401 and then is converted to a baseband signal by the quadrature demodulator 403.

Next, the baseband signal is converted to a digital baseband signal by the A/D converter 405. The training of the equalizer 407 starts, when AGC (Automatic Gain Control) control is completed by the wireless-portion establishment signal 423 in the preamble signal 421 of the frame (see FIG. 6).

In an example of the embodiment of the present invention, the equalizer 407 may be a Viterbi equalizer. In the Viterbi equalizer, when training thereof is started, the impulse response of the transmission channel is estimated by the use of a known training signal. The tap coefficient of the equalizer that has been determined by the estimation of the impulse response of the transmission channel is made fixed (frozen). Then, the start delimiter detection unit starts detecting the start delimiter (425 of FIG. 6) that is embedded at the ending unit of the preamble signal.

When the start delimiter detection unit 409 detects the start delimiter, signal bit from the next bit downward is deemed to be effective data. Thus, the reception of the user data is started.

The assembly/disassembly unit 410 executes error checks and error corrections of the received user data. Thereafter, the resultant user data are transmitted in the form of IP packets through the router 800 to the internet.

When the start delimiter detection unit 409 detects the start delimiter, the antenna control disable signal 450 is made active (ON) to be inputted into the antenna control unit 200. During the period when the antenna control enable signal 350 from the antenna beacon signal receiver 300 is active, the arbitration unit 230 in the antenna control unit 200 arbitrates between the antenna control enable signal and the antenna control disable signal and performs preferential control of the antenna control disable signal over the antenna control enable signal.

Concretely, even when the antenna control enable signal 350 is active (ON), if the antenna control disable signal 450 is also active, antenna direction control the antenna direction optimum control unit 210 is prohibited.

At this time, the signal received by the antenna beacon signal receiver 300 is temporarily written into the antenna beacon signal accumulation unit 220 and held therein.

And, when the reception of the user data is completed and the antenna control disable signal 450 is made OFF, the antenna beacon signal stored in the antenna beacon signal accumulation unit 220 is inputted into the antenna direction optimum control unit 210. Then, the optimum control of the antenna direction is started.

Referring to FIG. 5, at the time t1, the reception of the user data overlaps with the control of the antenna. In this case, both the antenna control disable signal 450 and the antenna control enable signal 350 are made active. However, the control of the antenna by the antenna control unit 200 is temporarily prohibited. Therefore, the control of the antenna is not started from the time t1 but is started from the time t2 when the reception of the user data is ended. In this way, the occurrence of errors in the reception data is avoided by the control of the antenna direction which is prohibited during the reception of the user data. Therefore, it is possible to avoid the degradation of the transmission quality.

What is claimed is:

1. A wireless internet access system, wherein a flying object is connected with an earth station connected with an internet, wherein:
said flying object comprises:
a LAN;
a flying router connected with said LAN for communicating bi-directionally with said earth station; and
user's terminals connected with said LAN, and said earth station comprises:
an antenna for tracking said flying object;
antenna control means for controlling the direction of said antenna;
an antenna beacon signal receiver connected with said antenna;
a MODEM connected with said antenna beacon signal receiver;
an earth router for accessing to said internet; and
timing separation means for separating the receiving timing of data transmitted by said flying object from the control timing of said direction of said antenna, when said receiving timing overlaps with said control timing.

2. The wireless internet access system according to claim 1, wherein said timing separation means delays said control timing, compared with said receiving timing.

3. The wireless internet access system according to claim 1, wherein:
said MODEM includes disable signal generation means for generating a disable signal for controlling said direction of said antenna, when a start delimiter is detected in a frame transmitted by said flying object, and
said antenna beacon signal receiver includes enable signal generation means for generating an enable signal for controlling said direction of said antenna, when a beacon signal transmitted by said flying object is detected,
said antenna control means includes antenna control start means for starting controlling said direction of said antenna, which:
inputs said disable signal and said enable signal;
prohibits said controlling, when said enable signal becomes active during the period when said disable signal is active; and
starts said controlling, when said disable signal becomes inactive.

4. The wireless internet access system according to claim 3, wherein said antenna control means comprises:
optimum control means for controlling said direction of said antenna;
accumulation means for storing said beacon signal; and
arbitration means for generating an accumulation control signal for controlling writing-in and reading-out of said beacon signal into and out of said accumulation means.

5. The wireless internet access system according to claim 3, wherein said MODEM comprises:
a frequency down-converter for converting signals in frames received by said antenna;
an quadrature demodulator for inputting the output from said frequency down-converter;
an A/D converter for converting the output from said quadrature demodulator;
an equalizer for inputting the output from said A/D converter;
a start delimiter detection unit for inputting the output from said equalizer and for detecting a start delimiter in said frames received by said antenna;
an assembly/disassembly unit for assembling and disassembling said frames;
an encoder for inputting the output from said assembly/disassembly unit;
a D/A converter for converting the output from said encoder;
an quadrature modulator for modulating the output from said D/A converter; and
a frequency up-converter for converting the output from said quadrature modulator,
wherein said start delimiter detection unit makes said disable signal active and outputs the active disable signal into said antenna control means, when said start delimiter detection unit detects said start delimiter at a preamble of each of said frames.

6. The wireless internet access system according to claim 1, wherein said flying object is an air plane.

7. The wireless internet access system according to claim 1, wherein said flying router comprises:
a internal router connected with said LAN;
a flying MODEM connected with said flying router;
a beacon signal generator for generating a beacon signal;
a flying antenna for transmitting said beacon signal and for communicating bi-directionally with said earth station.

8. An earth station connected with an internet for communicating a LAN on a flying object, which comprises:
an antenna for tracking said flying object;
antenna control means for controlling the direction of said antenna; and
postponing means for generating a disable signal for postponing said controlling until said earth station completes receiving data in a frame transmitted by said flying object, when the timing of receiving said data in said frame transmitted by said flying object overlaps with the timing of receiving a beacon signal transmitted by said flying object.

9. An earth station connected with an internet for communicating a LAN on a flying object, which comprises:
an antenna for tracking said flying object;
antenna control means for controlling the direction of said antenna; and
a MODEM for modulating and demodulating signals to and from said flying object;
accumulation means for storing a beacon signal transmitted by said flying object; and
a router connected with said MODEM for accessing to said internet, wherein said MODEM comprises:
disable signal generation means for making a disable signal active, when said MODEM detects a start delimiter in a preamble of a frame transmitted by said flying object, and for outputting the active disable signal; and
antenna control start means for prohibiting said controlling on the basis of said active disable signal, when the timing of receiving data in said frame overlaps with the timing of receiving said beacon signal, for allowing said antenna beacon signal to be stored into said accumulation means, and for starting said controlling, when said MODEM completes receiving said data in said frame.
